(19) United States
(12) Patent Application Publication
(10) Pub. No.: US 2024/0401407 A1
(43) Pub. Date: Dec. 5, 2024

(54) PLEATED WINDOW COVERING FOR DOUBLE HUNG FENESTRATION UNIT

(71) Applicant: Pella Corporation, Pella, IA (US)

(72) Inventors: Brian L. Kolb, Pella, IA (US); Adam C. Austin, Pella, IA (US); Evan R. Vande Haar, Pella, IA (US)

(73) Assignee: Pella Corporation, Pella, IA (US)

(21) Appl. No.: 18/524,686

(22) Filed: Nov. 30, 2023

Related U.S. Application Data
(60) Provisional application No. 63/470,474, filed on Jun. 2, 2023.

(51) Int. Cl. E06B 9/52

(52) U.S. Cl. CPC E06B 9/522; E06B 2009/527; E06B 2009/528

(57) ABSTRACT

A screen assembly for a fenestration unit having a frame and a window sash, the screen assembly including a screen assembly frame having a first side member, a second side member, and an upper member, and a screen housing extending between the first side member and the second side member of the screen assembly, the screen housing having a first housing member and a second housing member, wherein the housing forms a screen retention space between the first and second housing members when the screen assembly is in a closed position, a screen positioned between the first and second housing members when the screen assembly is in the closed position, the pleated screen including a first end coupled to the first housing member and a second end coupled to the second housing member, and a catch element extending from the housing and configured to be coupled to the window sash.

### CROSS RELATED APPLICATION

This application claims priority to U.S. Provisional Patent Application No. 63/470,474, entitled “Pleated Window Covering for Double Hung Fenestration Unit”, filed Jun. 2, 2023, the contents of which are hereby incorporated by reference in its entirety.

### TECHNICAL FIELD

The present description relates generally to fenestration assemblies, systems, and methods. Specifically, the description relates to fenestration assemblies including screen assemblies.

### BACKGROUND

Fenestration assemblies that include moveable glass panels can also include a screen mounted in a fixed position to keep out insects or other pests, more colloquially known as “bugs.” In some cases, the screen can be removed when not needed. However, in both cases, when the screen is installed, viewing through at least one of the glass panels includes viewing through the screen, somewhat obscuring the view through the glass panel. Over time the screen can be continuously exposed to the elements, leading to an accumulation of airborne detritus on the screen, further obscuring the view.

What is needed are screen systems that are simple to use, do not obscure the view through the glass panels, and are aesthetically pleasing when in use and when not in use.

### SUMMARY

Various disclosed concepts relate to a screen assembly, a fenestration unit including a screen assembly, and associated methods.

According to one example (“Example 1”), a screen assembly for a fenestration unit having a frame and a window sash is provided, the screen assembly including a screen assembly frame configured to be installed onto the frame of the fenestration unit, the screen assembly frame including a first side member, a second side member, an upper member extending between the first side member and the second side member at an upper end; and a screen housing extending between the first side member and the second side member of the screen assembly, the screen housing having a first housing member and a second housing member, wherein the housing forms a screen retention space between the first and second housing members when the screen assembly is in a closed position, a screen positioned between the first and second housing members when the screen assembly is in the closed position, the pleated screen including a first end coupled to the first housing member and a second end coupled to the second housing member, and a catch element extending from the housing and configured to be coupled to the window sash.

According to another Example (“Example 2”), further to Example 1, the screen assembly frame includes a profile capable of being secured to the frame of the fenestration unit.

According to another Example (“Example 3”), further to Example 1, the screen assembly frame is capable of being positioned adjacent to the window sash of the fenestration unit.

According to another Example (“Example 4”), further to Example 1, the screen assembly frame includes a hinge member operable to be coupled to the frame of the fenestration, wherein the screen assembly frame is operable to pivot away from the fenestration unit about the hinge member.

According to another Example (“Example 5”), further to Example 1, the screen assembly frame includes a plurality of insect brushes operable to be positioned against the frame and the sash when installed in a fenestration unit.

According to another Example (“Example 6”), further to Example 5, the plurality of insect brushed form a substantially contiguous perimeter about the screen assembly frame.

According to another Example (“Example 7”), further to Example 1, the screen assembly includes a cord system including a cord extending through at least a portion of the screen and a cord terminal operable to couple to the screen housing to lock the cord relative to the screen housing.

According to an Example (“Example 8”), a fenestration unit includes a frame having a first portion, a second portion opposite the first portion, a first jamb extending between the first portion and the second portion, and a second jamb opposite the first jamb and extending between the first portion and the second portion, wherein the first jamb and the second jamb each include a first pocket; a sash including a first rail, a second rail opposite the first rail, a first stile extending between the first and second rails, and a second stile opposite the first stile and extending between the first and second rails, wherein the first and second stiles include extensions positioned in each first pocket of the first and second jamb such that the extensions are configured to translate within each corresponding first pocket relative to the frame; and a screen assembly including a screen assembly frame and a screen housing, the screen assembly frame configured to be installed onto the frame, the screen assembly frame including a first side member, a second side member, an upper member extending between the first side member and the second side member at an upper end and the screen housing extending between the first side member and the second side member of the screen assembly, the screen housing having a first housing member and a second housing member, wherein the housing forms a screen retention space between the first and second housing members when the screen assembly is in a closed position, a screen positioned between the first and second housing members when the screen assembly is in the closed position, the pleated screen including a first end coupled to the first housing member and a second end coupled to the second housing member, and a catch element extending from the housing and coupled to the window sash.

According to another Example (“Example 9”), further to Example 8, the first side member of the screen assembly frame is positioned in the first pocket of the frame and the second side member of the screen assembly frame is positioned in the second pocket of the frame.

According to another Example (“Example 10”), further to Example 8, the screen assembly frame includes a profile capable of being secured to the frame of the fenestration unit.

According to another Example (“Example 11”), further to Example 8, the screen assembly frame is capable of being positioned adjacent to the window sash of the fenestration unit.

According to another Example (“Example 12”), further to Example 8, the screen assembly frame includes a hinge member coupled to the frame of the fenestration, wherein the screen assembly frame is operable to pivot away from the fenestration unit about the hinge member.

According to another Example (“Example 13”), further to Example 8, the screen assembly frame includes a plurality of insect brushes positioned against the frame and the sash when installed in a fenestration unit.

According to another Example (“Example 14”), further to Example 13, the plurality of insect brushed form a substantially contiguous perimeter about the screen assembly frame.

According to another Example (“Example 15”), further to Example 8, a cord system including a cord extending through at least a portion of the screen and a cord terminal operable to couple to the screen housing to lock the cord relative to the screen housing.

According to another Example (“Example 16”), further to Example 8, the catch element is positioned on the housing such that the housing engages with the first rail of the sash.

According to an Example (“Example 17”), a method of providing a screen assembly on a fenestration unit is provided, wherein the fenestration unit includes a frame defining a pocket, and a sash engaged with the pocket of the frame such that the sash is configured to translate along the pocket relative to the frame, the method comprising: engaging a screen assembly frame of a screen assembly with the frame of the fenestration unit; and coupling a second housing member of the screen assembly to the sash of the fenestration unit such that a catch element of the first housing member engages with the sash.

According to another Example (“Example 18”), further to Example 17, the method including rotating the screen assembly frame out from the frame of the fenestration unit.

According to another Example (“Example 19”), further to Example 17, the method including adjusting tension of cords of the screen assembly.

According to another Example (“Example 20”), further to Example 19, the method including locking the cords with a cord terminal.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a front view of an interior-facing side of a double hung fenestration unit or assembly with a screen assembly, according to some embodiments of the disclosure.

FIG. 2 is a front view of an exterior-facing side of a double hung fenestration unit a screen assembly, according to some embodiments of the disclosure.

FIG. 3 is a front view of a screen assembly including a screen assembly frame, according to some embodiments of the disclosure.

FIG. 4 is a side view of a screen assembly including a screen assembly frame, according to some embodiments of the disclosure.

FIG. 5 is another side view of a screen assembly including a screen assembly frame, according to some embodiments of the disclosure.

FIG. 6 is section view of a screen assembly including a screen assembly frame positioned in a frame of a fenestration unit, according to some embodiments of the disclosure.

FIGS. 7A and 7B are views of a screen assembly including a screen assembly frame rotated out from a frame of a fenestration unit, according to some embodiments of the disclosure.

FIG. 8 is a perspective view of a portion of a screen assembly, according to some embodiments of the disclosure.

FIG. 9 is a side view of a portion of a screen assembly, according to some embodiments of the disclosure.

FIG. 10 is side section view of a screen assembly including a screen assembly frame positioned in a frame of a fenestration unit, according to some embodiments of the disclosure.

FIG. 11 is another side section view of a screen assembly including a screen assembly frame positioned in a frame of a fenestration unit, according to some embodiments of the disclosure.

FIG. 12 is a perspective view of a cord routing system, according to some embodiments.

FIG. 13 is a front view of a screen assembly and routing system, the routing system using a primary and secondary cord for supporting the screen assembly, according to some embodiments.

FIGS. 14A, 14B, 14C, 14D, 14E, and 14F are close up views of transitions in direction of a cord in a cord routing system, according to some embodiments.

FIGS. 15A, 15B, and 15C are various views of a cord terminal, according to some embodiments.

FIG. 16 is a perspective view of a cord terminal being positioned with a screen assembly, according to some embodiments.

FIGS. 17 and 18 are perspective views of a corner lock, according to some embodiments.

FIG. 19 is a perspective view of a hinge members, according to some embodiments.

FIGS. 20A, 20B, 20C, 20D, 20E, 20F, 20G, 20H, and 201 are views of a

screen assembly implemented with a double hung window, according to some embodiments.

While the inventive concepts addressed herein are amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Some inventive concepts provided by this disclosure relate to integrated screen features, enhanced bug sealing between sashes, and others. These inventive concepts are examples only, and further inventive concepts, as well as their advantages and associated functions will be appreciated from this disclosure.

In some examples, fenestration units are provided that allow a user to view through the glazing panels of a fenestration unit without the obstruction of a screen or the like while having the ability to open the fenestration unit and have a screen unit to prevent debris and pests from entering through the fenestration unit. Furthermore, the disclosed device provides the advantage of a retractable screen that does not have a mechanism that biases the fenestration unit or pulls the fenestration unit to a closed position (e.g., in designs where the fenestration unit is slidably closed with a minimal force). In some examples, the required force to slide the fenestration unit may be maintained at a minimal level because the screen assembly does not exert a force on the sliding panels for rehousing or recoiling the screen. Another advantage includes a tighter fit between the screen and the frame during use, thus minimizing the space through which debris and pests may enter through the fenestration unit. Another advantage includes a pleated screen that is released in a relatively flatter configuration so as to minimize obstruction of the view due to pleating. Another advantage includes a screen assembly that may be installed on a new fenestration unit or that may be retrofitted onto an existing fenestration unit.

This disclosure is not meant to be read in a restrictive manner. For example, the terminology used in the application should be read broadly in the context of the meaning those in the field would attribute such terminology. Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

With respect terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error or minor adjustments made to optimize performance, for example. In the event it is determined that individuals having ordinary skill in the relevant arts would not readily ascertain values for such reasonably small differences, the terms “about” and “approximately” can be understood to mean plus or minus 10% of the stated value.

Certain terminology is used herein for convenience only. For example, words such as “top,” “bottom,” “upper,” “lower,” “left,” “right,” “horizontal,” “vertical,” “upward,” and “downward” merely describe the configuration shown in the figures or the orientation of a part in the installed position. Indeed, the referenced components may be oriented in any direction. Similarly, throughout this disclosure, where a process or method is shown or described, the method may be performed in any order or simultaneously, unless it is clear from the context that the method depends on certain actions being performed first.

As used herein, the phrase “within any range defined between any two of the foregoing values” literally means that any range may be selected from any two of the values listed prior to such phrase regardless of whether the values are in the lower part of the listing or in the higher part of the listing. For example, a pair of values may be selected from two lower values, two higher values, or a lower value and a higher value.

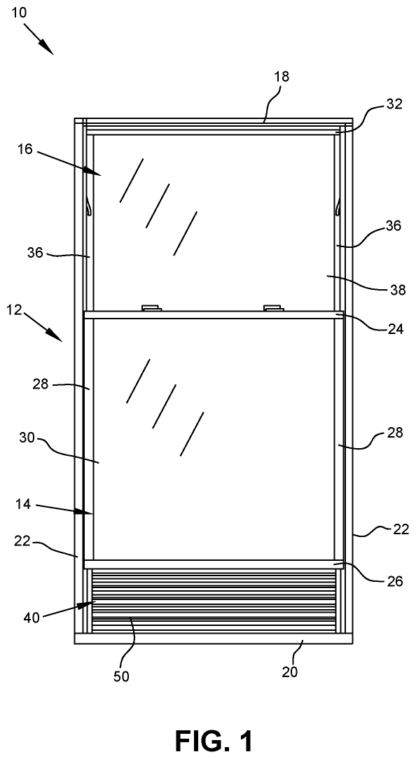

FIG. 1 is a front view of an interior-facing side of a fenestration unit 10, according to some embodiments of this disclosure. By “interior-facing side” it is meant the side of the fenestration unit 10 that typically faces toward an interior of a building structure into which the fenestration unit 10 is installed. As shown, the fenestration unit 10 is a double-hung window that includes a frame 12, a first sash 14, and a second sash 16. The frame 12 can include a first portion, or head 18, a second portion, or sill 20, and jambs 22. Together, the head 18, the sill 20, and the jambs 22 surround and support the first sash 14 and the second sash 16. The first sash 14 can include an upper rail 24, a lower rail 26, stiles 28, and a glazing 30. Together, the upper rail 24, the lower rail 26, and the stiles 28 surround and support the glazing 30. The second sash 16 can include an upper rail 32, a lower rail 34 (not shown), stiles 36, and glazing 38. Together, the upper rail 32, the lower rail 34, and the stiles 36 surround and support the glazing 38. In some embodiments, the frame 12 includes pockets within which the first and second sash 16 ride when transitioning between an open configuration and a closed configuration.

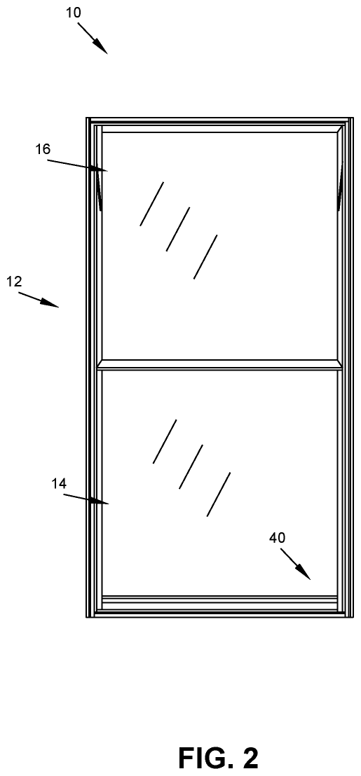

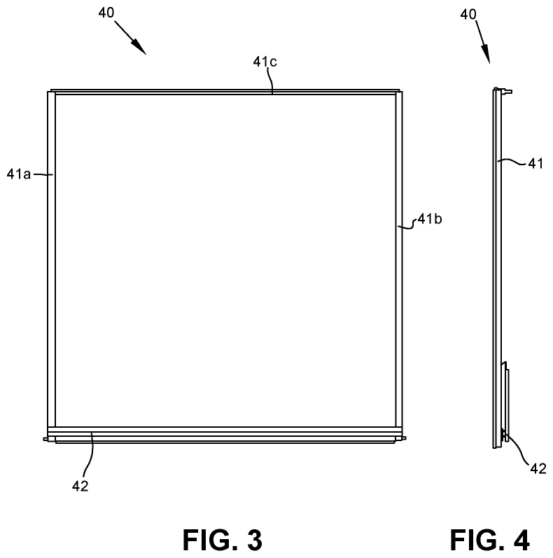

As shown in FIG. 1, fenestration unit 10 includes a screen assembly 40. The screen assembly 40 includes a screen 50 that is operable extend across openings formed when the first sash 14 is opened on the fenestration unit 10. The screen assembly 40 can extend between the sill 20 and the lower rail 26 of the first sash 14 and cover the opening formed between the sill 20 and the lower rail 26. In FIG. 1, the first sash 14 is shown in an open configuration. That is, the first sash 14 is not in contact with the sill 20. It will be understood that a fenestration unit 10 may include any number of screen assemblies 40 as appropriate in specific embodiments (e.g., a single hung fenestration unit may include a single screen assembly 40). FIG. 2 illustrates an exterior facing side of the fenestration unit 10. In FIG. 2, the first sash 14 is in the closed configuration.

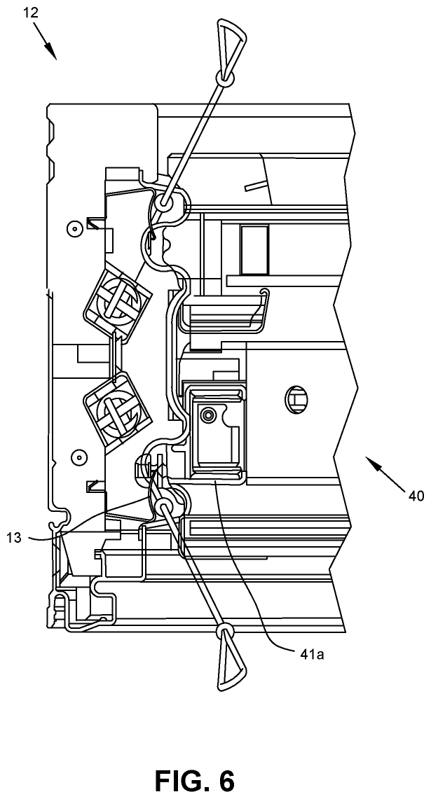

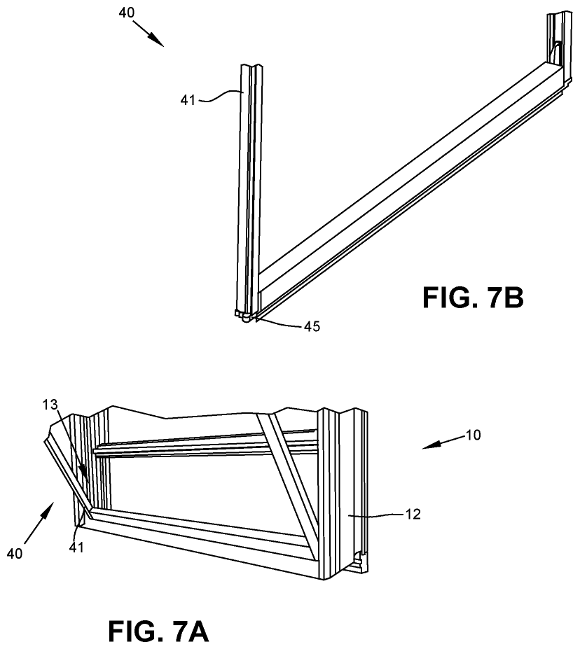

FIG's. 3-5 show front and side views of a screen assembly 40 according to some embodiments. As shown, the screen assembly 40 includes a screen assembly frame 41 including two side members 41a, 41b, and an upper member 41c. The screen assembly frame 41 further includes the screen housing 42, which is positioned and extends between the first and second side members 41a, 41a. Thus, the four sides of the screen assembly frame 41 are defined by the two side members 41a, 41b, the upper member 41c, and the screen housing 42. The screen assembly frame 41 is operable to be positioned within the fenestration unit 10, for example between the frame 12 and below the second sash 16. The screen assembly frame 41 may be installed in newly manufactured fenestration units 10 or may be installed on existing fenestration units 10 (e.g., retrofitted onto an existing window). The screen assembly frame 41 may be provided with various profiles to engage with the frame 12 of the fenestration unit 10. For example, FIG. 6 illustrates one of the side members 41a of the screen assembly 40 being positioned with the frame 12 of the fenestration unit 10. The side member 41a has a profile that is operable to engage with a spring 13 and profile of the frame 12 of the fenestration unit 10. In some embodiments, the screen assembly frame 41 is positioned extending at least partially into the pockets (e.g., pocket 13 of FIG. 7A) of the frame 12 of the fenestration unit 10.

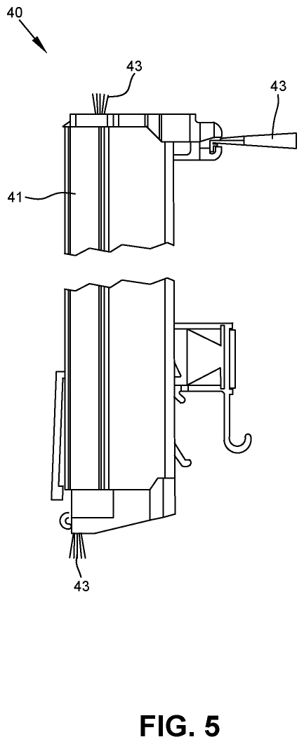

The various portions of the screen assembly frame 41 may include features and accessories that facilitate coupling to fenestration units 10 and for forming a weather and/or insect barrier when installed. For example, the two side members 41a, 41b, the upper member 41c, and the screen housing 42 may each be provided with profiles that are operable to engage with corresponding features of the fenestration unit 10 such that the screen assembly 40 may be positioned and retained within the fenestration unit 10. The two side members 41a, 41b, the upper member 41c, and the screen housing 42 may also include insect brushes 43 (see FIG. 5) that limit ingress of insects into a building via spaces that may be present between the screen assembly 40 and the fenestration unit 10.

Referring to FIGS. 7A and 7B, the screen assembly 40 is operable to be rotated outward from the frame 12 of the fenestration unit 10. This allows a user to have easy access to surfaces for cleaning the screen assembly 40 and the fenestration unit 10. When the screen assembly 40 is implemented on a double hung window unit, the screen assembly 40 may be rotated outward to allow the upper sash (e.g., the second sash 16) to be lowered and tilted inward in order to clean the fenestration unit 10. The screen assembly 40 includes a hinge member 45 that is operable to engage with the fenestration unit 10 and about which the screen assembly 40 is capable of pivoting or rotating when the screen assembly frame 41 is rotated outward. For example, the hinge member 45 may be positioned and engaged with a pocket 13 of the frame 12 of the fenestration unit 10. The hinge member 45 allows the screen assembly 40 to rotate about the hinge member 45 such that a portion of the screen assembly 40 remains engaged with the frame 12 of the fenestration unit 10 while another portion of the screen assembly 40 is rotated outward (e.g., out of or away from the pocket 13). The hinge member 45 may be coupled to the screen assembly 40 (e.g., the frame 41), may be incorporated into other portions of the screen assembly 40 (e.g., end caps or braces coupling portions of the frame 41 together) or may be manufactured directly onto the frame 41 or housing members 44, 46. By rotating the screen assembly 40 outward, the second sash 16 is provided space within which the second sash 16 is capable of translating and being tilted inward for cleaning. Various embodiment of a hinge member 45 may be implemented such as illustrated in FIG. 19.

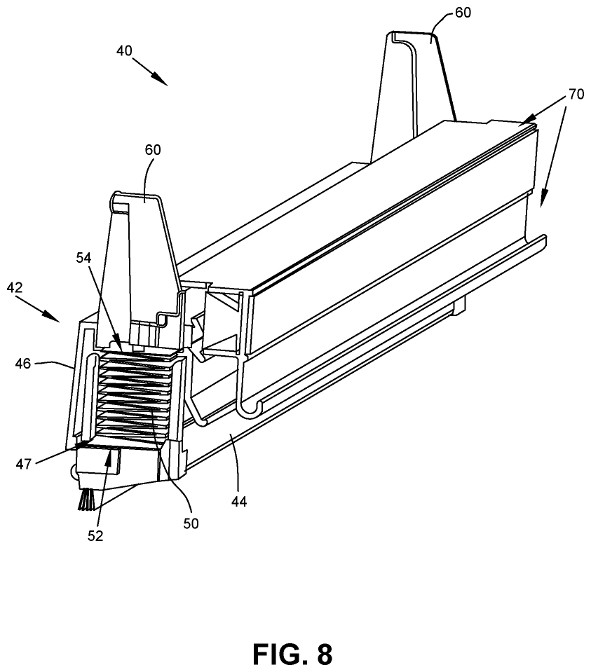

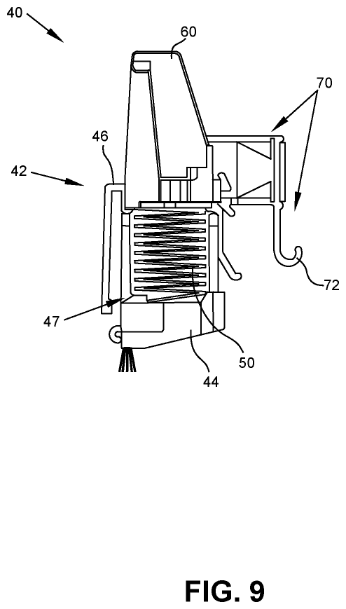

Referring to FIGS. 8 and 9, the screen assembly 40 includes a first housing member 44 and a second housing member 46. The first and/or second housing members 44, 46 may form a screen retention space 47 operable to retain a screen 50. For example, the first housing member 44 includes a screen retention space 47 in which the screen 50 is retained when the fenestration unit 10 is in a closed configuration. The second housing member 46 acts as a cover for the screen retention space 47 when the fenestration unit 10 is in a closed configuration. As shown, in various examples, the screen 50 is positioned substantially inside of the screen housing 42 when the screen housing 42 is in a closed position (e.g., as shown in FIG. 8), or in alternative terms the screen 50 is enclosed within the screen housing 42 when the screen housing 42 is in the closed position. The screen 50 may be disposed in the screen housing 42 such that screen 50 is pleated or folded. The screen 50 (e.g., pleated screen) includes a first end 52 coupled to the first housing member 44 and a second end 54 coupled to the second housing member 46. The screen 50 may be coupled to the screen housing 42 via various coupling mechanisms (e.g., plastic welding, sewing, mechanical fasteners, etc.). The screen assembly 40 further includes a coupling member 70 that is operable to be coupled to the first sash 14. It is understood that components of the screen assembly 40 may be coupled to other components of the fenestration unit 10 and may removably coupled to the remaining components of the screen assembly 40. For example, the coupling member 70 may be coupled to (e.g., mechanical and/or adhesive attachments) to the first sash 14 to provide removable coupling of the first sash 14 to the screen assembly 40. Thus, in those embodiments in which the screen assembly 40 may be rotated away from the frame 12, portions of the screen assembly 40 may remain positioned with other components of the fenestration unit 10 such as the first sash 14.

In some embodiments, the screen assembly 40 includes end caps 60 that facilitate positioning of the screen assembly 40 as part of the fenestration unit 10. The end caps 60 may serve various functions which will be described hereafter. The end caps 60, according to some embodiments, are positioned on the screen housing 42 of the screen assembly 40 (e.g., at the longitudinal ends of the either the first or second housing members 44, 46).

Because the screen 50 is configured to extend across openings when the first and second sashes 14, 16 of the fenestration unit 10 are opened, at least a portion of the screen assembly 40 may be coupled to one of the first and second sashes 14, 16 and at least a portion of the screen assembly 40 may be coupled to the frame 12 of the fenestration unit 10 (e.g., either to the frame 12 directly or to the frame 12 via the screen assembly frame 41). In some embodiments, the screen assembly 40 is coupled to the first and second sash 14, 16 via the screen assembly frame 41 and the end caps 60 translate within the screen assembly frame 41. The screen assembly frame 41 defines pockets (not shown), which may be similar to the pocket 13 of the frame 12, within which the end caps 60 translate during movement of the screen assembly 40. In some embodiments, the coupling member 70 optionally engages with one of the first and second sashes 14, 16 such that the coupling member 70 and the screen assembly 40 generally can be disengaged from the sash 14, 16. In some embodiments, the coupling member 70 may extend from the first or second housing member 44, 46. It will be understood that the coupling member 70 can help facilitate engagement and coupling of the screen assembly 40 with one of the first and second sashes 14, 16.

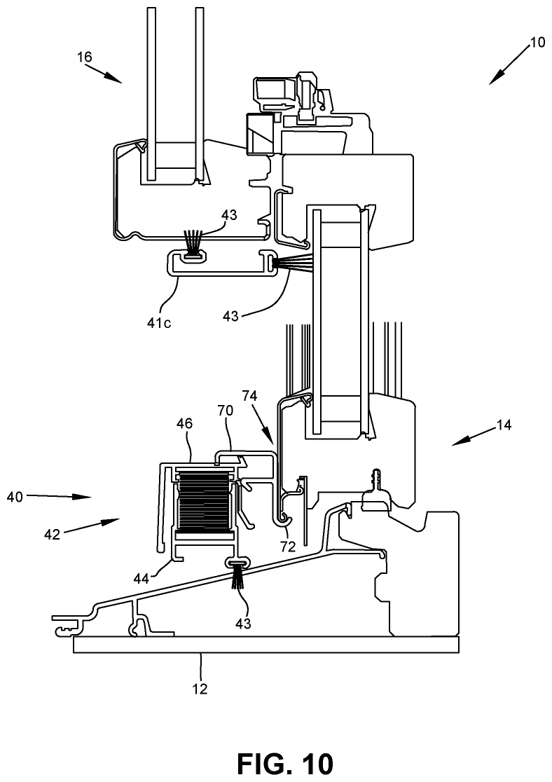

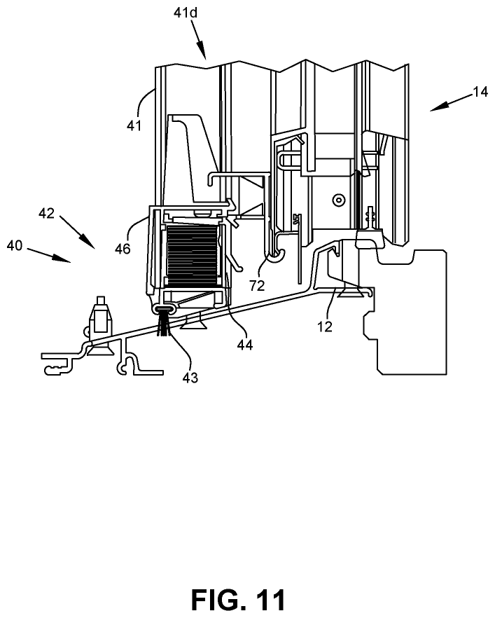

Referring now to FIG. 10, the screen assembly 40 is illustrated coupled to the fenestration unit 10. More specifically, the screen housing 42 is coupled to the first sash 14. This may be accomplished by coupling a hook 72 around a corresponding member of the first sash 14. In some embodiments, an adhesive 74 may be provided between the screen housing 42 and the first sash 14. FIG. 11 illustrates the screen assembly frame 41 positioned with the frame 12. The end cap 60 of the screen assembly 40 is shown positioned in the screen assembly frame 41. The end caps 60 are at least partially positioned within the pockets 41 defined within the screen assembly frame 41. The pockets 41d extend along at least a portion of the length of the screen assembly frame 41 in the direction in which the first sash 14 translates during opening and closing. The end caps 60 and the pockets 41d are sized and shaped to correspond to each other to allow for a secure coupling while promoting translation of the end caps 60 within the pockets 41d. Various screen assembly housings 42 may be provided including those shown in FIGS. 8-11, and those discussed in U.S. Patent Publication No. 2021/0238919A1 filed Jun. 15, 2020 by Evan Vande Haar, which is incorporated herein in its entirety.

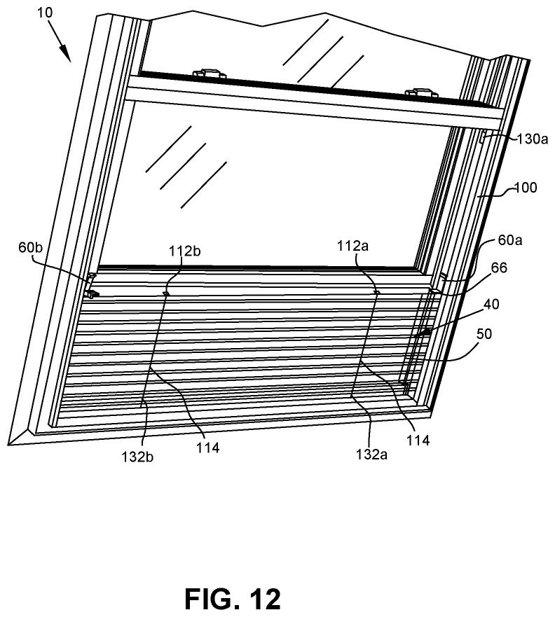

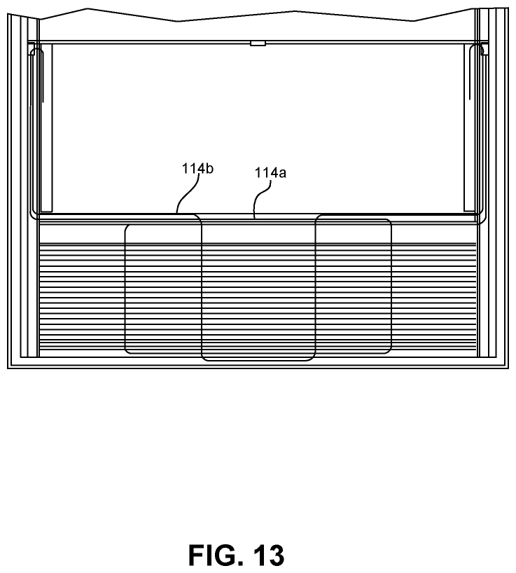

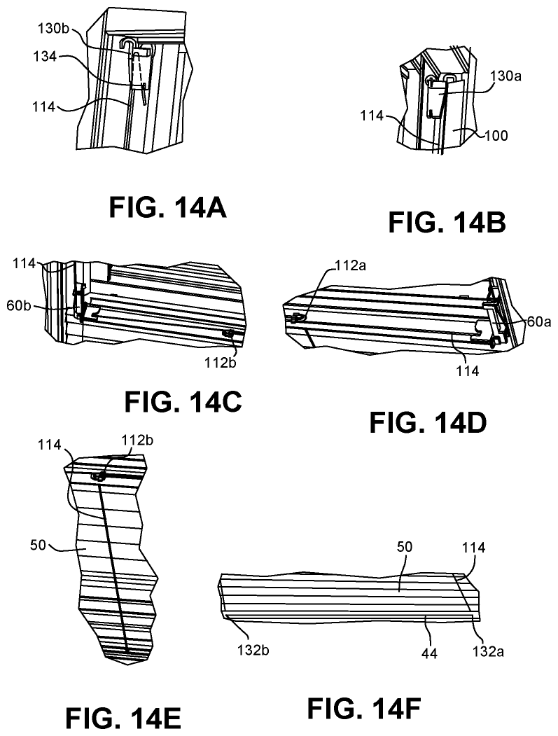

A cord system 100 is provided which is implemented to stabilize the screen 50 when in use. FIGS. 12 and 13 illustrate an embodiment of the cord system 100, or routing system. The cord system 100 includes cords 114 that may be routed through at least portions of the screen assembly 40 and positioned relative to the fenestration unit 10 to support the screen assembly 40 at predetermined or desired positions. The cord 114 and routing features may be considered a double support cord 114. For example, when a screen assembly 40 implements a double support cord 114, the routing of the cord 114 begins where the cord 114 is coupled to the fenestration unit 10. The cord 114 is knotted and the knotted portion of the cord 114 is captured in a first cord terminal 130a (see also FIG. 14B). The first cord terminal 130a may be coupled to the fenestration unit 10 using various coupling techniques and features.

The cord 114 may be routed in a first direction to the first end cap 60a (see also FIG. 14D), the first end cap 60a may include a gliding surface 66 (see FIG. 12) operable to allow an about 90-degree turn (or any other appropriate angle of turn) in the cord 114 across the gliding surface 66. For example, the gliding surface 66 may have a low-friction surface forming an arc with a generous radius operable to allow the cord 114 to transition along that surface from the first direction to a second direction (e.g., about 90 degrees relative to the first direction) without causing excessive resistance and/or damage to the cord 114. The cord 114 is then routed past a first grommet 112a positioned on the screen assembly 40 and toward a second grommet 112b, such that the cord 114 engages the second grommet 112b (see also FIG's. 14C, 14D, and 14E). Each of the grommets 112 can include a transition surface (not shown) about which the cord 114 may transition from the second direction to a third direction (it is recognized that the third direction in some embodiments is the same direction as the first direction). The transition surface may include a low-friction surface forming an arc with a generous radius operable to allow the cord 114 to transition along that surface without causing excessive resistance and/or damage to the cord 114. The cord is routed, via the transition surface, through holes in the screen 50. The cord 114 is routed through a second hole 132b in the first housing member 44 (see also FIG. 14F). In some embodiments, the holes 132 do not include a transition feature for providing a smooth transition of the cord 114 between direction, thus increasing the friction and resistance of the cord 114 at the holes 132. In other embodiments, the first housing member 44 may include similar transition features as discussed previously along which the cord 114 is operable to transition from the third direction to a fourth direction, for example, via the holes 132. The cord 114 is then routed along the first housing member 44 and through a first hole 132a, where the first hole 132a may be operable to transition the direction of the cord 114. Because the cord routing can be symmetrical, it is understood that the features and directions may also be inversely positioned. For example, as shown in the figures, the first hole 132a is complementary to the second hole 132b, the first grommet 112a is complementary to the second grommet 112b, a second end cap 60b is complementary to the first end cap 60a, and a second cord terminal 130b is complementary to the first cord terminal 130a. Thus, the cord may be routed from the first hole 132a to the first grommet 112a (see also FIG. 14D), from the first grommet 112a past the second grommet 112b (e.g., such that the cord 114 overlap or crosses between the first and second grommets 112a, 112b) to the second end cap 60b (see also FIG's. 14C and 14D), and from the second end cap 60b to a second cord terminal 130b (see also FIG. 14A). The cord terminals 130 are operable to maintain the cord 114 at an appropriate tension. The cord terminals 130 may include slots 134 (see also FIG. 14A) to clinch and wrap the cord 114 to ensure positive engagement.

The cord system 100, or routing system described herein may provide stability of the first housing member 44 during operation, including when it is disconnected from the sash 14. Since cord 114 is operable to transition directions around sharp bends of the holes 132 on the first housing member 44, the first housing member 44 is able to be adjusted for level while the cord-hole interaction produces resistance to facilitate stability of the screen assembly 40.

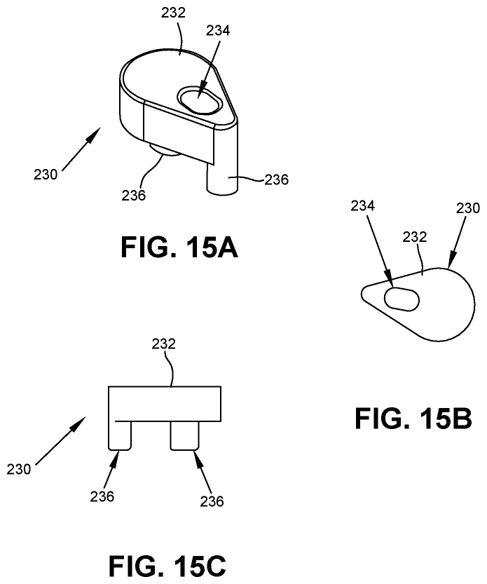

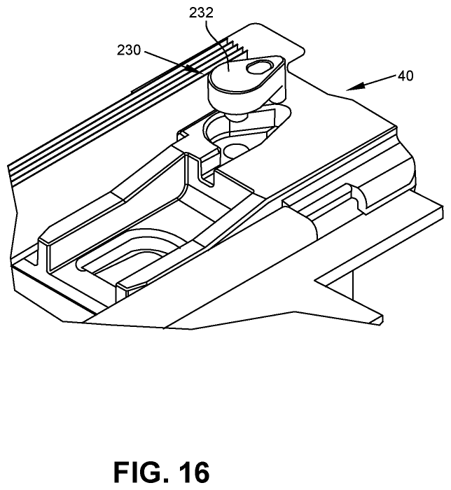

Referring now to FIGS. 15A-16, an alternative cord terminal 230 is illustrated, the cord terminal 230 may be operable to couple to lock the cord 114 to the screen assembly 40. The cord terminal 230 includes a body 232 and an aperture 234 defined through the body 232. The cord 114 is operable to pass through the aperture 234. As the body 232 is seated in the screen assembly 40, the cord 114 is locked into place such that the cord 114 cannot move relative to the cord terminal 230. The cord terminal 230 may further include alignment members 236 to facilitate alignment and coupling to the screen assembly 40. Tension on the cord 114 may be modified by removing the cord terminal 230, translating the cord 114 relative to the screen assembly 40, and re-inserting the cord terminal 230 to lock the cord 114.

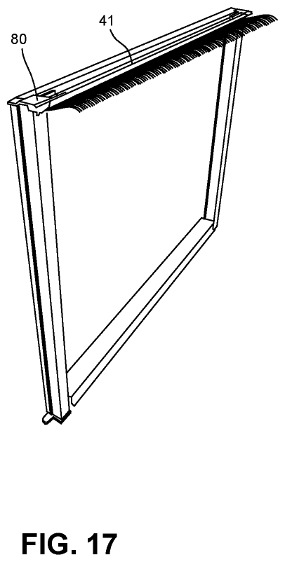

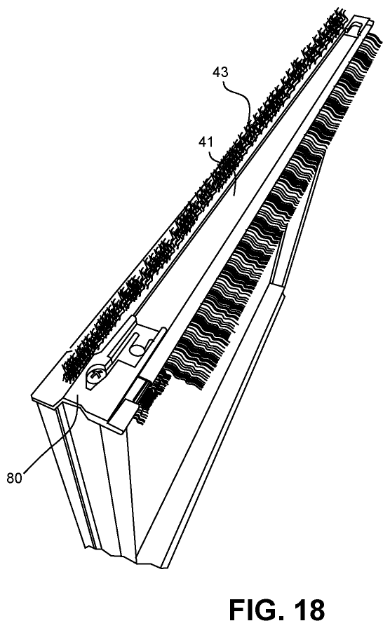

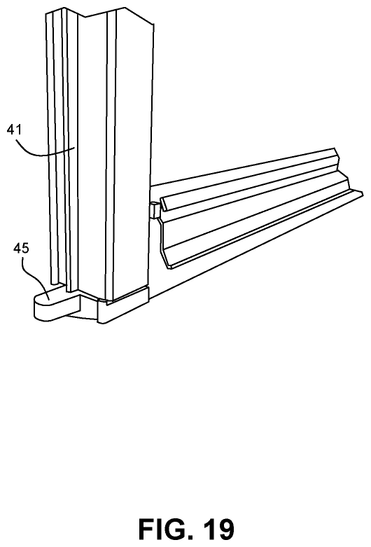

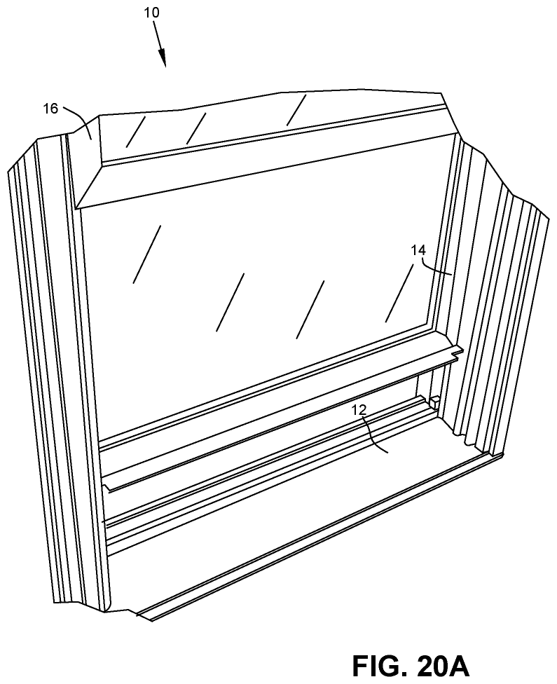

FIGS. 17-18 illustrates the screen assembly frame 41 with a corner lock 80 that is operable to engage with the frame 12 of a fenestration unit 10. The corner lock 80 may be positioned within a pocket of the frame 12 (e.g., pocket 13 of FIG. 7A) and can be releasably removed from engagement with the frame 12 of the fenestration unit 10 such that the screen assembly frame 41 is removeable or rotatable relative to the frame 12. The corner lock 80 may be formed of a flexible material to allow from engagement and removal of the screen assembly frame.

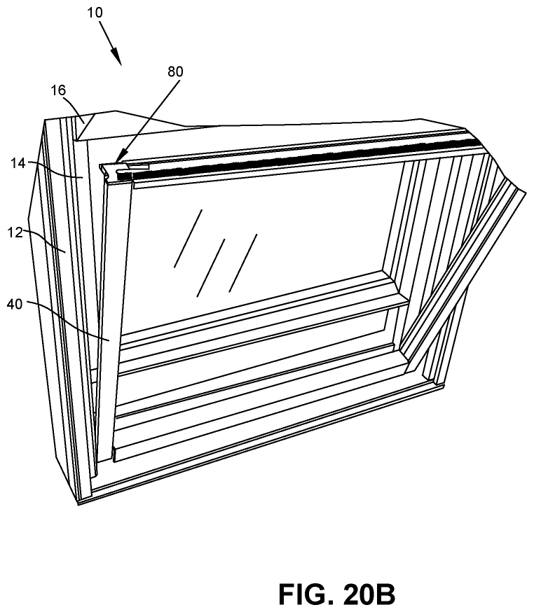

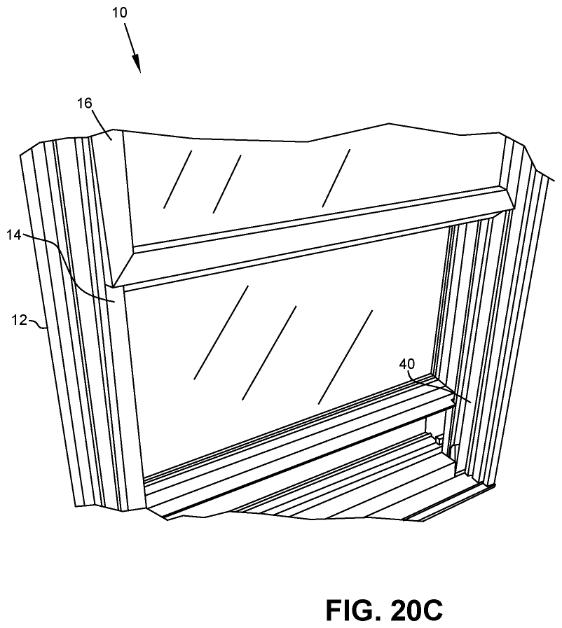

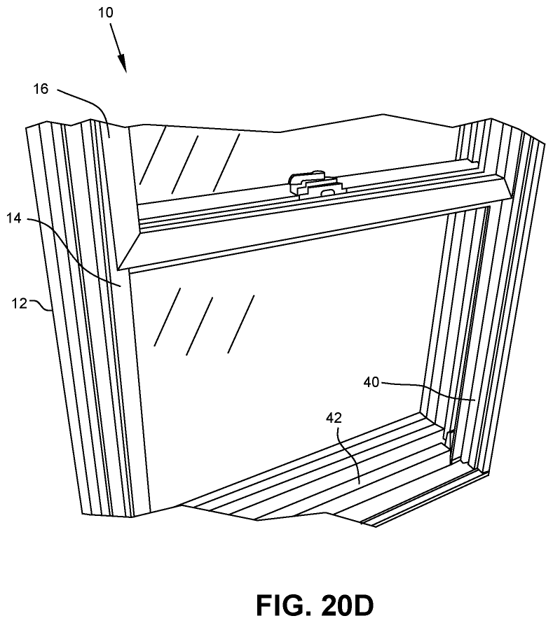

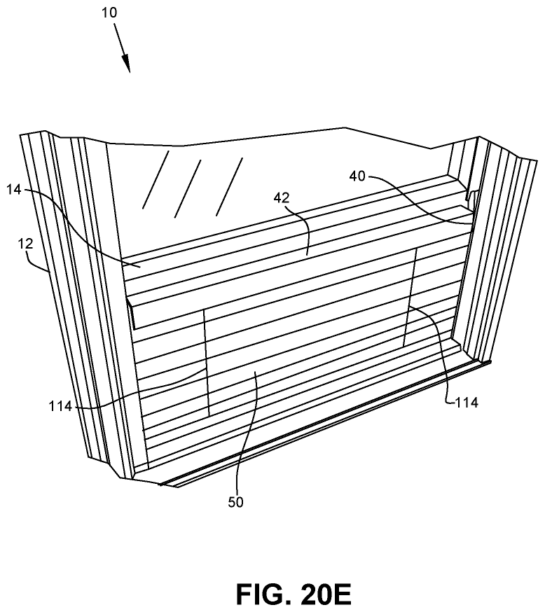

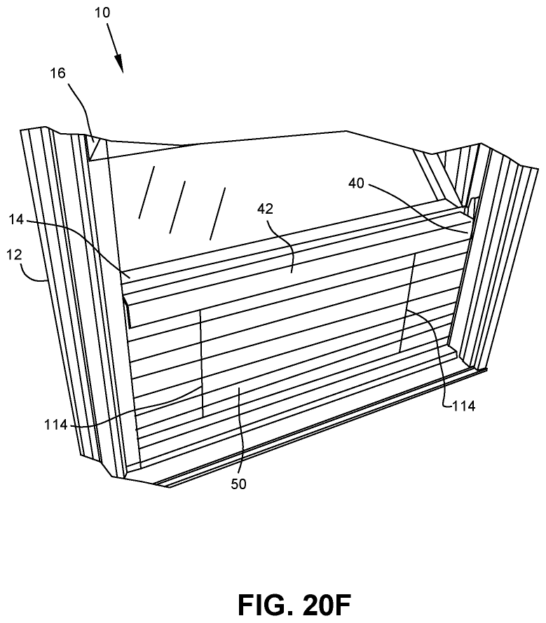

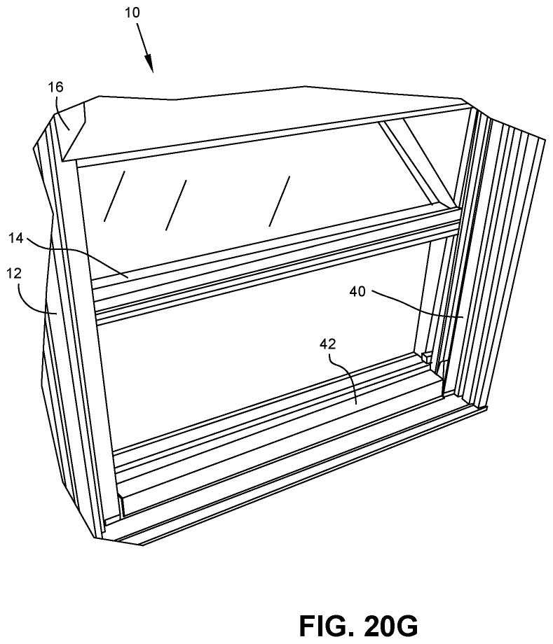

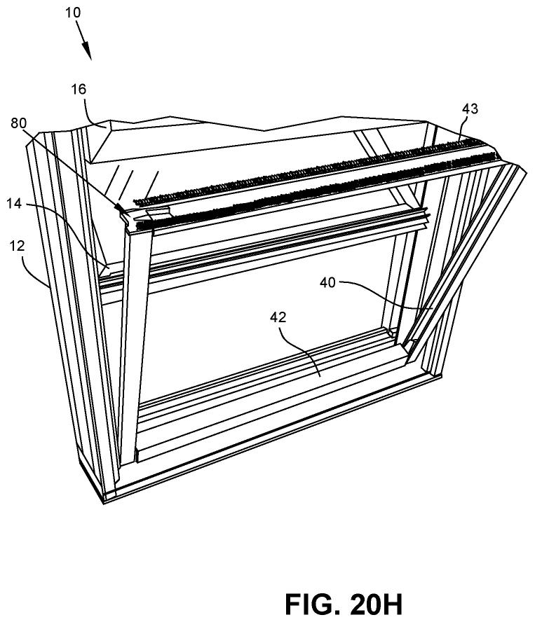

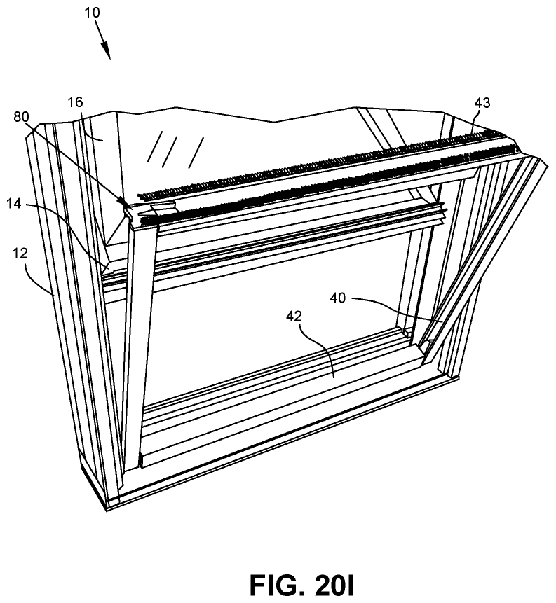

FIGS. 20A-201 illustrate a fenestration unit 10 that is a double hung unit with a first panel 14, a second panel 16 (e.g., a first sash 14 and a second sash 16), and a frame 12. The first and second panels 14, 16 are operable to slide and pivot within the frame 12. A screen assembly 40 is shown in connection with the fenestration unit 10.

FIG. 20A shows the fenestration unit 10 without the screen assembly 40 installed.

FIG. 20B shows the screen assembly 40 partially installed into the fenestration unit 10, where the hinge member 45 (see FIG. 19) is positioned with the frame 12. As shown, the screen assembly 40 is operable to pivot away from the fenestration unit 10 about the hinge member. The screen assembly 40 is rotated outward such that the first and second panels 14, 16 can be at least partially translated within the frame 12.

FIG. 20C shows the screen assembly 40 fully installed in the frame 12. The first panel 14 is able to translate within the frame 12 and the screen assembly 40 is positioned in the pocket of the frame 12 in which the second panel 16 is positioned.

FIG. 20D shows the screen assembly 40 being engaged with the first panel 14 when the first panel 14 is positioned in the closed configuration. The screen assembly 40 engages with the first panel 14 as previously described, such that screen housing 42 is removably coupled to the first panel 14 and can translate with the first panel 14.

FIG. 20E shows the first panel 14 engaged with the screen housing 42 such that the screen 50 deploys as the first panel 14 is opened.

FIG. 20F shows the first panel 14 rotated out and disengaged from the screen housing 42.

FIG. 20G shows the screen housing 42 returned to a stowed configuration. When stowed, the screen housing 42 may be positioned along a portion of the frame 12.

FIG. 20H shows the screen assembly 40 rotated out such that the second panel 16 may be toggled or transitioned between open and closed configurations.

FIG. 20I shows the screen assembly 40 rotated out and the second panel 16 translated downward, which allows the second panel 16 to be opened (translated and/or rotated for various reasons including cleaning).

The inventive concepts hereby addressed have been described above both generically and with regard to specific examples. It will be apparent to those skilled in the art that various modifications and variations can be made in the examples without departing from the scope of the disclosure. Likewise, the various components discussed in the examples are combinable. Thus, it is intended that the examples be viewed collectively, as a whole, as also intimating various modifications and variations of those specific examples.

1. A screen assembly for a fenestration unit having a frame and a window sash, the screen assembly comprising:
a screen assembly frame configured to be installed onto the frame of the fenestration unit, the screen assembly frame including a first side member, a second side member, an upper member extending between the first side member and the second side member at an upper end;
a screen housing extending between the first side member and the second side member of the screen assembly, the screen housing having a first housing member and a second housing member, wherein the housing forms a screen retention space between the first and second housing members when the screen assembly is in a closed position;
a screen positioned between the first and second housing members when the screen assembly is in the closed position, the screen including a first end coupled to the first housing member and a second end coupled to the second housing member; and
a catch element extending from the housing and configured to be coupled to the window sash.

2. The screen assembly of claim 1, wherein the screen assembly frame includes a profile capable of being secured to the frame of the fenestration unit.

3. The screen assembly of claim 1, wherein the screen assembly frame is capable of being positioned adjacent to the window sash of the fenestration unit.

4. The screen assembly of claim 1, wherein the screen assembly frame includes a hinge member operable to be coupled to the frame of the fenestration, wherein the screen assembly frame is operable to pivot away from the fenestration unit about the hinge member.

5. The screen assembly of claim 1, wherein the screen assembly frame includes a plurality of insect brushes operable to be positioned against the frame and the sash when installed in a fenestration unit.

6. The screen assembly of claim 5, wherein the plurality of insect brushed form a substantially contiguous perimeter about the screen assembly frame.

7. The screen assembly of claim 1, further comprising a cord system including a cord extending through at least a portion of the screen and a cord terminal operable to couple to the screen housing to lock the cord relative to the screen housing.

8. A fenestration unit comprising:
a frame having a first portion, a second portion opposite the first portion, a first jamb extending between the first portion and the second portion, and a second jamb opposite the first jamb and extending between the first portion and the second portion, wherein the first jamb and the second jamb each include a first pocket;
a sash including a first rail, a second rail opposite the first rail, a first stile extending between the first and second rails, and a second stile opposite the first stile and extending between the first and second rails, wherein the first and second stiles include extensions positioned in each first pocket of the first and second jamb such that the extensions are configured to translate within each corresponding first pocket relative to the frame;
a screen assembly including a screen assembly frame and a screen housing, the screen assembly frame configured to be installed onto the frame, the screen assembly frame including a first side member, a second side member, an upper member extending between the first side member and the second side member at an upper end and the screen housing extending between the first side member and the second side member of the screen assembly, the screen housing having a first housing member and a second housing member, wherein the housing forms a screen retention space between the first and second housing members when the screen assembly is in a closed position;
a screen positioned between the first and second housing members when the screen assembly is in the closed position, the screen including a first end coupled to the first housing member and a second end coupled to the second housing member; and
a catch element extending from the housing and coupled to the window sash.

9. The fenestration unit of claim 8, wherein the first side member of the screen assembly frame is positioned in the first pocket of the frame and the second side member of the screen assembly frame is positioned in the second pocket of the frame.

10. The screen assembly of claim 8, wherein the screen assembly frame includes a profile capable of being secured to the frame of the fenestration unit.

11. The screen assembly of claim 8, wherein the screen assembly frame is capable of being positioned adjacent to the window sash of the fenestration unit.

12. The screen assembly of claim 8, wherein the screen assembly frame includes a hinge member coupled to the frame of the fenestration, wherein the screen assembly frame is operable to pivot away from the fenestration unit about the hinge member.

13. The screen assembly of claim 8, wherein the screen assembly frame includes a plurality of insect brushes positioned against the frame and the sash when installed in a fenestration unit.

14. The screen assembly of claim 13, wherein the plurality of insect brushed form a substantially contiguous perimeter about the screen assembly frame.

15. The screen assembly of claim 8, further comprising a cord system including a cord extending through at least a portion of the screen and a cord terminal operable to couple to the screen housing to lock the cord relative to the screen housing.

16. The fenestration unit of claim 8, wherein the catch element is positioned on the housing such that the housing engages with the first rail of the sash.

17. A method of providing a screen assembly on a fenestration unit, wherein the fenestration unit includes a frame defining a pocket, and a sash engaged with the pocket of the frame such that the sash is configured to translate along the pocket relative to the frame, the method comprising:
engaging a screen assembly frame of a screen assembly with the frame of the fenestration unit; and
coupling a second housing member of the screen assembly to the sash of the fenestration unit such that a catch element of the first housing member engages with the sash.

18. The method of claim 17, further comprising rotating the screen assembly frame out from the frame of the fenestration unit.

19. The method of claim 17, further comprising adjusting tension of cords of the screen assembly.

20. The method of claim 19, wherein adjusting tension of the cords of the screen assembly includes locking the cords with a cord terminal.
